(19) United States
(12) Patent Application Publication
(10) Pub. No.: US 2008/0042393 A1
(43) Pub. Date: Feb. 21, 2008

(54) Suspension arrangement

(76) Inventor: Peter William Humphreys, Red Hill (AU)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/892,220

(22) Filed: Aug. 21, 2007

(30) Foreign Application Priority Data
Aug. 21, 2006 (AU) 2006904539
Jun. 25, 2007 (AU) 2007903411

(51) Int. Cl. B60G 11/04

(52) U.S. Cl. 280/124.175

(57) ABSTRACT

The present invention generally relates to a suspension arrangement for a vehicle the suspension arrangement includes an axle having a proximal end which is pivotably mounted by a pivot mount to the vehicle, and a distal end which includes a mount for mounting a ground engaging means, the pivot mount allowing the distal end of the axle to move in an upward direction about the pivot mount; and at least one leaf spring rigidly mounted to the vehicle. In operation, at least a portion of the leaf spring engages a portion of the axle in order to resist upward movement of the distal end of the axle about the pivot mount.

### RELATED APPLICATIONS

This application claims the benefit of Australia patent 2006904539 filed Aug. 21, 2006 and Australia patent application 2007903411 filed Jun. 25, 2007, the entire disclosures of both applications are hereby incorporated by reference.

### BACKGROUND OF THE INVENTION

1. Field of the Invention

The present invention generally relates to a suspension arrangement. The invention is applicable to vehicles, such trolleys, trailers, automobiles and the like and it will be convenient to hereinafter disclose the invention in relation to that exemplary application. However, it is to be appreciated that the invention is not limited to that application and could be used as a suspension arrangement between any ground engaging member and a body supported therefrom.

2. Description of the Prior Art

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Suspensions arrangements typically include a system of shock absorbers and linkages between a vehicle and its wheels used to bias the impact of road noise, bumps, and vibrations on the cargo carried in the vehicle.

In the context of trailers, suspension arrangements have been relatively simple constructions in the past due to the hauling function provided by trailers. Most existing trailer suspensions are of a solid-axle, leaf-spring type configuration in which one or more U-shaped leaf springs are fastened, typically welded, to the chassis of the trailer with a solid wheel axle perpendicularly clamped to the base of the U-shape of leaf springs. The wheels are mounted directly to the wheel axle. In this arrangement, the resilience of the leaf springs provide the biasing function for the suspension arrangement. This arrangement has found wide spread usage in trailers because the arrangement is cheap, simple and easy to manufacture.

However, it has been found that the existing systems can be very difficult to repair if a user does not have easy access to a welding machine. In this respect, most solid-axle leaf-spring type suspension systems are welded to the chassis of the trailer. Accordingly, if a spring or other welded component breaks during use, a user cannot conduct an on the spot repair to allow timely further use of the trailer. This can be problematic if the trailer is damaged or breaks in a remote location.

It would therefore be desirable to provide an alternate suspension arrangement which can be used for a trailer. Preferably, the alternative suspension arrangement can be more easily manufactured and repaired than the existing solid-axle, leaf-spring type suspension system. Preferably, this suspension system would be formed from a number of elements which are releasably securable together so as to facilitate ready repair if necessary.

### SUMMARY OF THE INVENTION

According to the present invention, there is provided a suspension arrangement for a vehicle, the suspension arrangement including an axle having a proximal end which is pivotably mounted by a pivot mount to the vehicle, and a distal end which includes a mount for mounting a ground engaging means, the pivot mount allowing the distal end of the axle to move in an upward direction about the pivot mount; and at least one leaf spring rigidly mounted to the vehicle, wherein, in operation, at least a portion of the leaf spring engages a portion of the axle in order to resist upward movement of the distal end of the axle about the pivot mount.

Accordingly, the present invention provides an alternative suspension arrangement in which the axle can be upwardly pivoted relative to a pivot mount located in or mounted to a vehicle, and which upward movement is resisted and preferably biased using at least one leaf spring. This provides a relatively simple and flexible arrangement, particularly in comparison to the existing solid axle, leaf-spring type arrangements which tend to be comparatively rigid in construction.

The at least one leaf spring can be mounted in any position on the vehicle relative to the axle such that in operation at least a portion of the leaf spring engages a portion of the axle to resist upward movement of the axle about the pivot mount. As can be appreciated, this could position the leaf spring above the axle, to one side of the axle, mounted a certain distance away from the pivot mount or mounted generally proximate to the pivot mount. In each case, the leaf spring is configured to have a portion which engages the axle in operation. In a preferred embodiment, the at least one leaf spring is mounted generally vertically above the axle. This configuration preferably provides a biasing means above the axle which resists upward movement of the axle about the pivot mount. More preferably, the leaf spring is configured such that the end of the leaf spring rigidly mounted to the vehicle is mounted to the vehicle at a location which is proximate to the pivot mount. In one embodiment, the leaf spring extends from the vehicle longitudinally along the length of the axle. As can be appreciated, such a configuration provides a relatively simple elongate spring configuration. In an alternative embodiment, the leaf spring extends from the vehicle generally perpendicularly to the length of the axle. This embodiment provides a more compact form, particularly if the leaf spring extends generally parallel to a longitudinal side of the vehicle. This particular embodiment is particularly advantageous when used in retrofitting this suspension arrangement to an existing vehicle.

The suspension arrangement can include any number of leaf springs. However, preferably the suspension arrangement includes two or more leaf springs. The at least one leaf spring can include of any type of resilient material such as elastic materials, metals, rubber type materials or the like. In a preferred form however, each leaf spring is manufactured from steel.

The at least one leaf spring can be rigidly mounted to the vehicle in a number of configurations. In one embodiment, the at least one leaf spring includes a proximal end which is rigidly mounted to the vehicle and a distal end which is connected to the axle. Of course in this embodiment, the distal end of the at least one leaf spring would preferably be connected to the axle in a manner which allows the leaf spring to longitudinally move relative to the length of the axle. The at least one leaf spring may bias movement of the axle in all directions that the axle moves about the pivot mount for example in both the upward and downward direction. In an alternative embodiment, the at least one leaf spring includes a proximal end fastened to the vehicle and a distal end which is free. In this embodiment, the leaf spring is configured such that in operation at least a portion of the at least one leaf spring between the proximal and distal end substantially engages the axle to resist only the upward movement of the axle.

In order to allow for easy assembly, disassembly and repair of the suspension assembly, it is preferable that each of the respective components of the suspension system are releasably secured together. Any combination of releasable fasteners would be suitable, including bolts and nuts, clips, locks, latches, screws, straps or the like. In a preferable embodiment, each of the respective components is generally releasably fastened together using a bolting system.

The pivot mount can be formed as part of the chassis of the vehicle or other portion thereof or can form part of a mounting fixture which is fastened or otherwise secured to the vehicle. In one preferred embodiment, the suspension arrangement further includes a mounting fixture which is secured to the vehicle. The mounting fixture includes the pivot mount. In some embodiments the mounting fixture can also include a leaf spring fastener in which one end of the leaf spring is rigidly mounted. As can be appreciated, the leaf spring fastener can include any number of clamping, bolting or other fastening arrangements. However, the at least one leaf spring is preferably releasably secured to or within the mounting fixture.

In one preferred arrangement, the leaf spring fastener includes a clamping plate arrangement which clamps one end of at least one of the leaf springs within the mounting fixture. Preferably, the clamping plate arrangement includes an upper and lower plate between which the at least one leaf spring is clamped. The clamping plate therefore can be affixed or otherwise fastened to the axle and then the at least one leaf spring fastened between each of the upper and lower plate, and these plates clamped together to secure the at least one leaf spring within the suspension arrangement.

In some embodiments, the suspension arrangement further includes a longitudinal fastener which is inserted though each of the leaf springs to restrain longitudinal movement of each leaf spring relative to each other. The longitudinal fastener provides an additional fastening means which generally resists longitudinal movement of each leaf spring at that point relative to each other. Preferably, the longitudinal fastener is a pin which is inserted through each of the leaf springs. In some embodiments, the longitudinal fastener is also fastened to or otherwise secured with a portion of the suspension arrangement such as the mounting fixture or a portion of the vehicle chassis or the like.

In some embodiments, the clamping plate arrangement also includes a mounting portion for the axle. This interconnection can be provided by one or more fasteners such as U-bolts, a clamp or the like or by an interlocking feature in the clamping plate arrangement specifically configured to receive the axle.

The pivot mount can comprise any suitable pivot mount member which facilitates pivot mountable movement between the mounting fixture and axle. In one embodiment, the pivot mount comprises one or more bolts which releasably secure the axle to the mounting fixture.

The suspension arrangement according to the present invention can be fastened to a portion of the vehicle in any suitable manner. Preferably, the suspension arrangement is fastened to the chassis of the vehicle. In some embodiments, the suspension system is welded to a portion of the chassis of the vehicle. In other embodiments, one or more fasteners are used to fasten the suspension arrangement to a portion of the chassis. Preferably, the fasteners are releasable fasteners. In one preferred embodiment, the suspension arrangement further includes one or more chassis fasteners which fasten the mounting fixture to a portion of a chassis of the vehicle. Preferably, the one or more chassis fasteners include one or more U-bolts.

In some embodiments, the suspension arrangement of the present invention forms part of a wheel assembly of the present invention. In such an embodiment it is preferable that the axle is a wheel axle and the ground engaging means is a wheel. However, it should be appreciated that the ground engaging means could be in other embodiments, skis, tracks, rollers or the like. In one embodiment, the wheel assembly includes a common bracing axle which interconnects two or more adjoining suspension arrangements. Preferably, the bracing axle is configured to span between suspension arrangements provided on opposite sides of a vehicle. In this form, the bracing axle can be common to two suspension arrangements, each of which is located on respective sides of the vehicle. In other embodiments, the vehicle includes one or more independent suspension assemblies which are connected to the chassis of the vehicle at discrete points.

In one embodiment, the mounting fixture includes a sleeve section which receives a bracing axle and a pivot mount section in which the axle is pivotably connected. In one embodiment, the mounting fixture and axle have a rectangular cross-section. If the sleeve of the mounting fixture has a corresponding cross-section, the axle can have an interference fit with this sleeve.

As can be appreciated, the suspension arrangement could be used on any number of vehicles for example in cars, trucks, buses, tractors, caravans, trailers, carts or the like. In one preferred form, the vehicle is a trailer. Preferably, the trailer includes two or more suspension systems according to the present invention.

### BRIEF DESCRIPTION OF THE DRAWINGS

The present invention will now be described with reference to the FIGS. of the accompanying drawings, which illustrate particular preferred embodiments of the present invention, wherein:

FIG. 1 is lower plan view of a trailer incorporating one preferred embodiment of the suspension arrangement according to the present invention.

FIG. 2 is an upper plan view of section A of FIG. 1 without a wheel fitted to the wheel axle.

FIG. 3 is a front elevation view of the suspension arrangement shown in FIG. 2 with the wheel attached to the wheel axle.

FIG. 4 is the same view as shown in FIG. 4 with the wheel removed from the wheel axle.

FIG. 5 is a perspective view of the suspension system shown in FIGS. 3 and 4 with the wheel removed from the wheel axle.

FIG. 6 is a top plan view of the suspension system shown in FIG. 5.

FIG. 7 is a side view of the suspension system shown in FIG. 5.

FIG. 8 is a perspective view of another preferred embodiment of the suspension arrangement according to the present invention.

FIG. 9 a perspective view showing a similar view of the suspension arrangement as shown in FIG. 8 with the wheel removed from the wheel axle.

FIG. 10 is a perspective view showing a side view of the suspension system shown in FIG. 9.

FIG. 11 is a more detailed perspective view of the fastening system between the axle and the chassis of a trailer incorporating the suspension arrangement as shown in FIGS. 8 to 10.

FIG. 12 is a perspective view of yet another preferred embodiment of the suspension arrangement according to the present invention.

### DESCRIPTION OF THE PREFERRED EMBODIMENTS

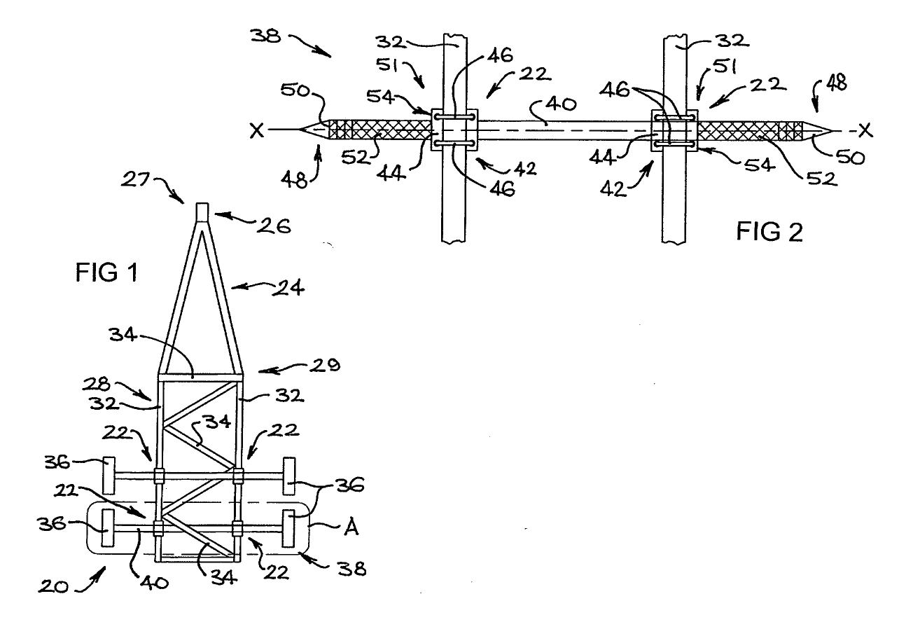

Referring to FIG. 1, there is shown a lower plan view of a trailer 20 which incorporates a suspension arrangement 22 according to one preferred embodiment of the present invention. As shown in FIG. 1, the trailer 20 is constructed to be hitched to a vehicle (not shown) such as a tractor or car through triangular hitching frame 24. The hitching frame 24 includes a hitch 26, typically having a ball type construction at a first distal end 27, and is connected to the chassis 28 at another proximal end 29.

As with any typical trailer configuration, the chassis 28 has a skeletal framework construction, made up of frame members, including metal sections, welded, bolted or otherwise rigidly connected together. In the illustrated embodiment, the framework of the chassis 28 includes two longitudinally arranged side beams 32 which are interconnected by a series of transverse cross-members 34. The chassis 28 has four wheels 36 transversely attached on wheel assemblies 38 to each side of chassis 28. Each of the wheel assemblies 38 includes two spaced apart spring based suspension systems 22 positioned proximate to each of the longitudinally arranged side beams 32 of the chassis 28.

A more detailed view of one wheel assembly 38 is illustrated in FIG. 2, which shows an enlarged view of section A of FIG. 1. Referring to FIG. 2, the wheel assembly 38 is shown to include a central common bracing axle 40 which perpendicularly spans the gap between the two longitudinally arranged side beams 32. Each end of the bracing axle 40 is mounted in a mounting fixture 42, of which the top plate 44 is illustrated in FIG. 2. The bracing axle 40 defines a mounting axis X-X which runs along the length of the bracing axle 40 and through the mounting fixture 42. Each mounting fixture 42 is fastened to the chassis 28 of the trailer 20 using two U-bolts 46 which releasably fasten the mounting fixture 28 to a respective side beam 32.

Each wheel 36 is mounted on the distal end 48 of an elongate wheel axle 50. As can be appreciated, a wheel mount arrangement (not shown) that includes bearings, wheel rim and the like would be mounted on the distal end 48 of each wheel axle 50. Each wheel axle 50 is fastened within a pivot mount (not visible in FIG. 2) located in the mounting fixture 42 and extends generally axially outwardly along the mounting axis X-X from each mounting fixture 42. Above each wheel axle 50 is located four leaf springs 52 which provide the biasing force for the suspension arrangement 22. As will be explained in more detail later in the specification, the distal ends 54 of each leaf spring 52 are clamped within a clamping arrangement 60 formed between clamping plates 44 and 68 in the mounting fixture 42.

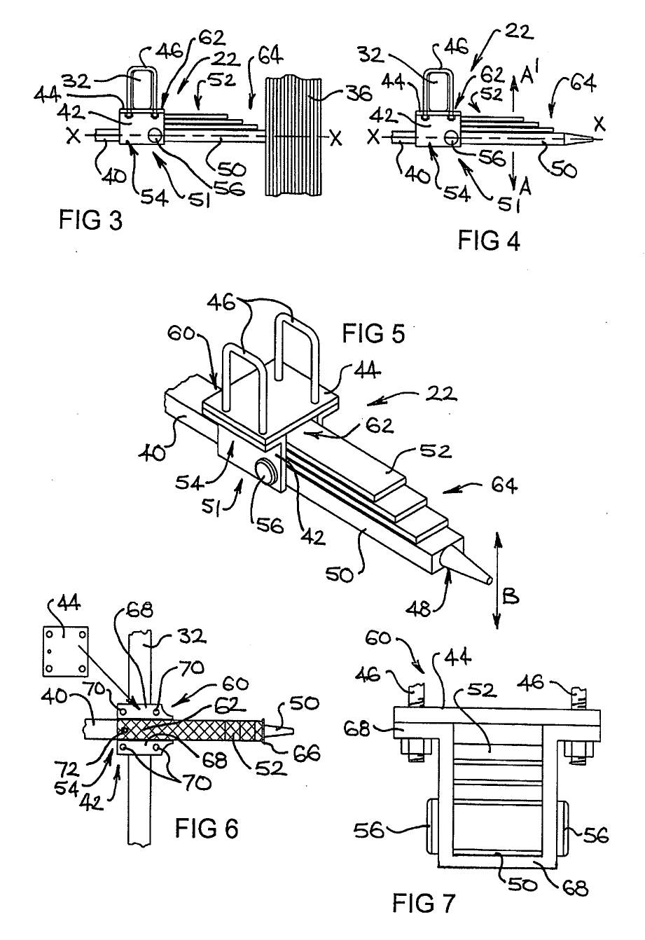

Referring now to FIGS. 3, 4 and 5, there are shown various side views of the right hand suspension arrangement 22 of the wheel assembly 38 shown in FIG. 2. In FIG. 3, the wheel assembly 38 has a wheel 36 fitted to the distal end 48 of the wheel axle 50, while in FIGS. 4 and 5, the wheel 36 has been removed. As illustrated, the bracing axle 40 is mounted within a sleeve 54 at a lower end of the mounting fixture 42. The end of the bracing axle 40 is clamped within the sleeve 54 between an upper plate 44 and lower plate 68 of the mounting fixture 42. The bracing axle 40 provides a transverse brace between the two suspension systems 22 of the wheel assembly 38.

The illustrated suspension system 22 is formed from the combination of the mounting fixture 42, wheel axle 50 and leaf springs 52. In this respect, the wheel axle 50 is pivotably connected at a proximate end 51 to the mounting fixture 42 through pivot bolt 56 located in sleeve 58 of the mounting fixture 42. As can be observed, the wheel axle 50 has a square cross-section which is located in a corresponding cross-sectional sleeve portion 58 of the mounting fixture 42. The sleeve portion 58 does not have a base (as best illustrated in FIG. 7). Accordingly, the distal end 48 of the wheel axle 50 is able to move upwardly and downwardly about the pivot mount 56, as shown by the arrows A, A′ and B in FIGS. 4 and 5. In the arrangement shown in FIGS. 4 and 5, this upward movement is restricted by the leaf spring 52, which is made from a resilient material such as a metal (for example steel or the like). Effectively, the resilience of the material provides downward biasing force against the upward movement of the wheel axle 50 when the axle engages the leaf spring 52. The leaf springs 52 therefore downwardly bias any upward movement of the wheel 36 relative to the chassis 32 of the trailer 20.

Accordingly, the biasing action of the suspension system 32 is provided by the biasing force the leaf spring 52 applied to the wheel axle 50. The illustrated leaf springs 52 are a series of four stacked rectangular plates of steel having a first proximal end 62 clamped within a clamping arrangement 60 in the mounting fixture, which extend outwardly above the wheel axle 50 parallel to the mounting axis X-X. As best shown in FIG. 4 and 5, each of the four illustrated leaf springs 52 have different and decreasing lengths from bottom to top providing a stepped configuration along the top of the wheel axle 50. This stepped structure provides a progressive biasing action which varies along the length of the wheel axle 50. In this respect, the biasing force is high closer to the mounting fixture 42 and pivot mount 56, because of the presence of four leaf springs 52. The biasing force is lowest near the distal end of the wheel axle 50. This range of biasing force is used to accommodate the amount of bend required in the leaf spring 52 the further the leaf spring 52 projects away from the pivot mount 56. In this respect, the more leaf springs 52 used, the stiffer the overall leaf spring 52 combination acting on the wheel axle 50 (the higher the biasing force), the harder it is to bend the leaf spring 52. Of course, the leaf spring 52 must be capable of bending significantly more at the distal end of the wheel axle 50 than near the pivot mount 56 due to the relative size of the arcuate movement at the respective points along the axle 52.

The clamping arrangement 60 which secures the leaf springs 52 within the mounting fixture 42 is shown in more detail in FIGS. 6 and 7. As best shown in FIG. 6, the clamping arrangement 60 is formed by a rectangular top plate 44 which is clamped to a lower plate 68. The lower plate 68 is integrally connected to the sleeves 54 and 58 which interconnect the bracing axle 40 and wheel axle 50 to the mounting fixture 42. In the illustrated configuration, the bracing axle 40 and wheel axle 50 are seated in an open cavity formed by the lower plate 68 such that the top plate 44 in combination with the leaf springs 52 provide the top or roof of each sleeve 54 and 58. However, as can be appreciated, in other embodiments, the lower plate 68 could form the roof of each sleeve 54 and 58, with the leaf springs 52 clamped between the top plate 44 and lower plate 68.

Accordingly, in the illustrated embodiment, the lower plate 68 has an upturned hat like configuration forming an open top cavity therein into which the bracing axle 40 and leaf springs 52 are located in a stacked arrangement (as best illustrated in FIG. 7). As shown in FIG. 6, the bracing axle 40 is placed in the cavity of the lower plate 68 about 2/3 along the length of the cavity. The proximal ends 62 of the leaf springs 52 are then laid on top of the bracing axle 40 with the distal ends 64 extending outwardly over the wheel axle 50. The height of the combination of the bracing axle 40 and leaf springs 52 is slightly, greater than the internal height of the lower plate's 68 cavity. Therefore, when the upper plate 44 is secured to the lower plate 68 using bolt holes 70 and U-bolts 48, the bracing axle 40 and leaf springs 52 are clamped between the lower plate 68 and upper plate 44. An optional pin or bolt (not illustrated) can be placed through the sleeve 54 and bracing axle 40 in order to fasten together the sleeve 54 and respective end of the bracing axle 40.

As best shown in FIG. 6, a restraining pin 72 is inserted through the proximal end 62 of each leaf spring 52 and through the bracing axle 40. The restraining pin 72 is inserted though each of the leaf springs 52 to restrain longitudinal movement of each leaf spring 52 relative to each other.

In use, with a wheel 36 fitted, the leaf springs 52 abut the upper surface of the wheel axle 50 as shown in FIGS. 3 to 6. In the illustrated arrangement, the distal ends 64 of the leaf springs 52 are free. Accordingly, the leaf springs 52 only provide a downward biasing force to resist upward movement of the wheel axle 50. Of course, in those arrangements in which the distal ends 64 of the leaf springs 52 are secured to the wheel axle 50, the leaf springs 52 would resist both upward and downward movement of the wheel axle 50 about the pivot mount 56. For example, as shown in FIG. 6, a U-bolt 66 could be used to secure at least one leaf spring to the wheel axle 50 in order to resist both upward and downward movement of the wheel axle 50 about the pivot mount 56. As can be appreciated, the U-bolt 66 is fastened to the axle in a manner which allows the leaf spring 52 to move longitudinally along the longitudinal length of the axle 50.

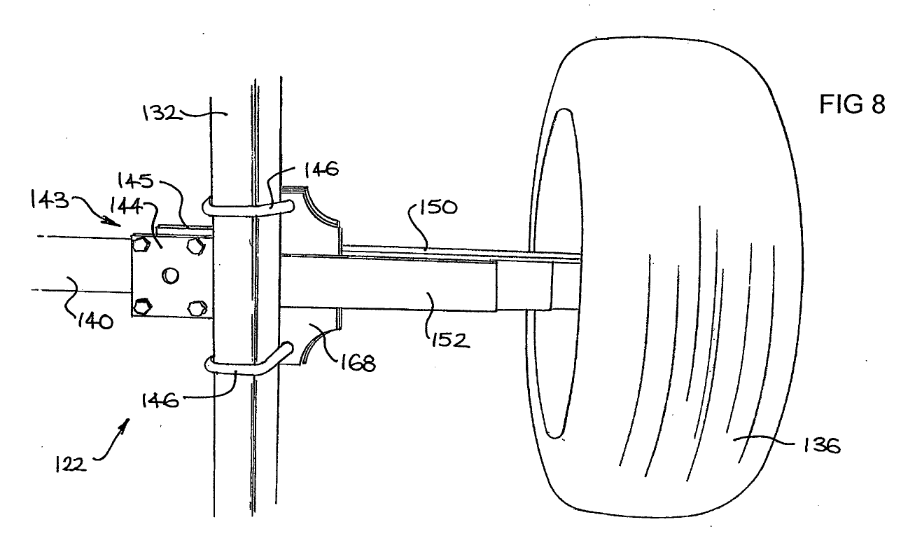

Referring now to FIGS. 8 to 11, there is shown a second embodiment suspension system 122 according to the present invention. As with the embodiment shown in FIGS. 3 to 7, this suspension system 122 can form part of a wheel assembly 38 of a trailer 20 as shown in FIGS. 1 and 2.

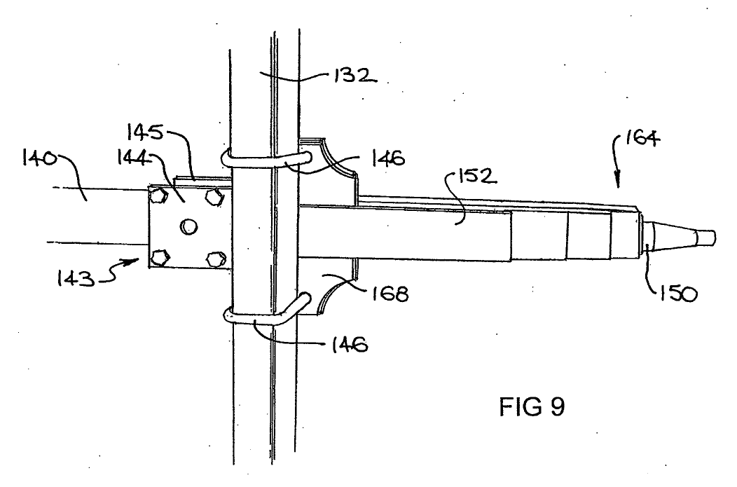

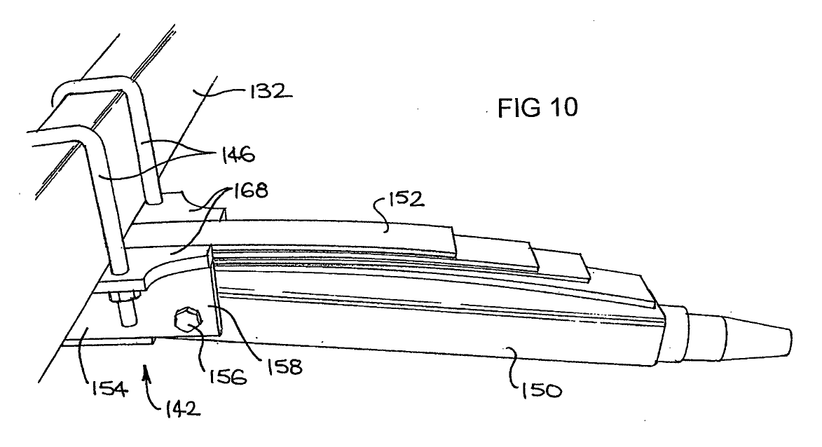

The function of this suspension system 122 is very similar to the function of the suspension system 22 described in relation to FIGS. 3 to 7, and accordingly similar reference numbers plus 100 have been used for like parts. In this respect, FIGS. 8 to 11 show various side views of the right hand suspension arrangement 122 of a wheel assembly 38 for trailer 20 such as for example is shown in FIG. 2. In FIG. 8, the suspension arrangement 122 has a wheel 136 fitted to the distal end 48 of the wheel axle 150, while in FIGS. 9 and 10, the wheel 136 has been removed. Again, the illustrated suspension system 122 is formed from an interconnected combination of the mounting fixture 142, wheel axle 150 and leaf springs 152, with the wheel axle 150 being pivotably connected to the mounting fixture 142 through pivot bolt 156 located in the sleeve 158 of the mounting fixture 142.

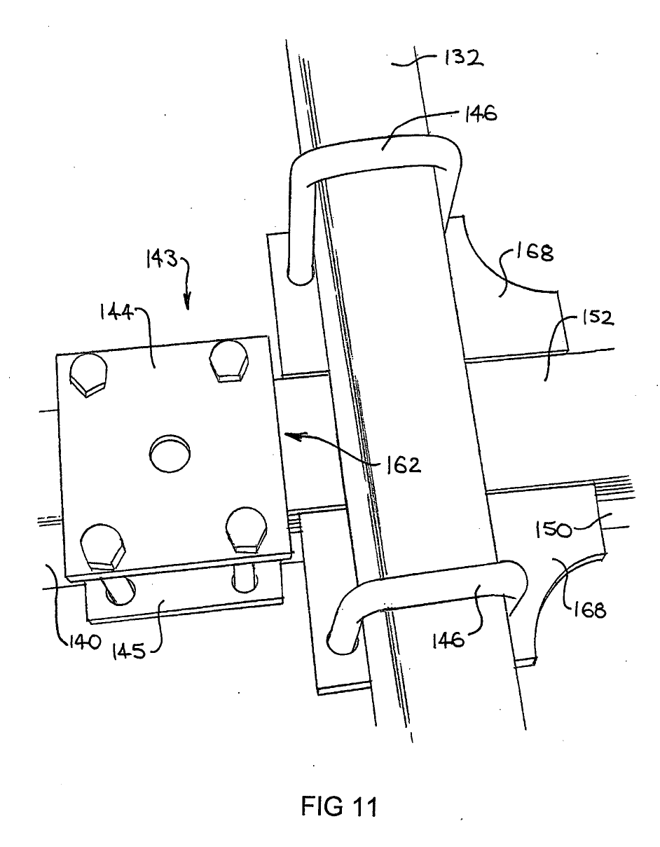

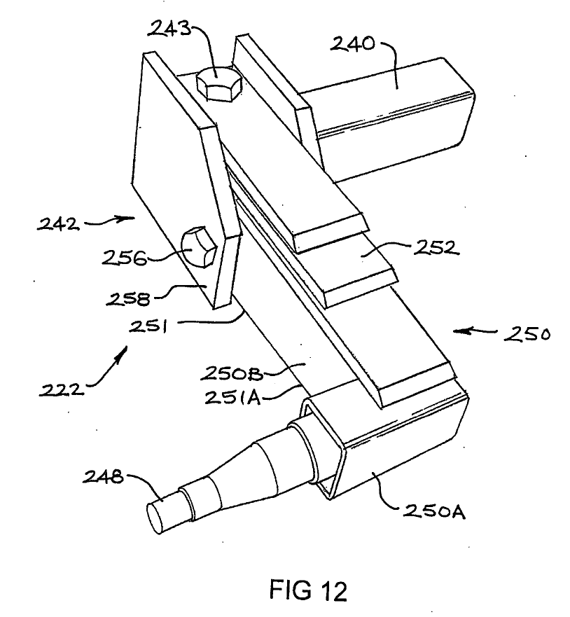

However, unlike the embodiment shown in FIGS. 3 to 6, the leaf springs 152 are clamped to the bracing axle 140 using a separate clamping arrangement 143 to the mounting fixture 142. In this embodiment, the mounting fixture 142 provides a sleeve 154 at a lower end of the mounting fixture 142 which receives one end of the bracing axle 140. As shown in FIG. 10, the mounting fixture 142 also provides a pivot mount sleeve mount 158 including a pivot bolt 156 about which the wheel axle 150 can pivot mount. However, the leaf springs 152 are clamped to the bracing axle 140 using a separate clamping arrangement 143 located inwardly of the mounting fixture 142 on the bracing axle 140. This clamping arrangement 143 comprises a square top plate 144 and square lower plate 145 which are clamped about the bracing axle 140 and proximal ends 162 (FIG. 11) of the leaf springs 152, sandwiching these components together. The lower plate 168 of the mounting fixture 142 is used to secure the mounting fixture 142 to the longitudinally arranged side beams 132 of the chassis 28 of a trailer 20 such as shown in FIG. 1 using U-bolts 146.

Referring now to FIG. 12, there is shown a third embodiment suspension system 222 according to the present invention. Again, as with the embodiments shown in FIGS. 3 to 7 and FIGS. 8 to 11, this suspension system 222 can form part of a wheel assembly 38 of a trailer 20 as shown in FIGS. 1 and 2. This particular suspension system 222 can be retrofitted to existing trailers having different suspension systems, including in situations where it is desired to keep the lateral distance between the wheels 36 of the trailer the same as the existing system.

The function of this suspension system 222 is very similar to the function of the suspension system 22 described in relation to FIGS. 3 to 7, and accordingly similar reference numbers plus 200 have been used for like parts. In this respect, FIG. 12 shows a perspective view of the left hand suspension arrangement 222 of a wheel assembly 38 for trailer 20 such as for example is shown in FIG. 2. It should be appreciated, that the suspension arrangement 222 is shown detached from a trailer with a wheel removed from the distal end 248 of the wheel axle 250. The corresponding right hand suspension arrangement would have a similar arrangement, but be a mirror image thereof.

Again, the illustrated suspension system 222 is formed from an interconnected combination of the mounting fixture 242, wheel axle 250 and leaf springs 252, with the wheel axle 250 being pivotably connected to the mounting fixture 242 through pivot bolt 256 located in the sleeve 258 of the mounting fixture 242. However, unlike the embodiment shown in FIGS. 3 to 6, mounting fixture 242 and leaf springs 252 extend perpendicularly to the longitudinal length of the central common bracing axle. In this embodiment, the bracing axle 240 laterally extends from the side of the mounting fixture 242. The bracing axle 240 is shown only in part, but in fact extends between mounting fixtures 242. The leaf springs 252 are clamped to the bracing axle 40 using a clamping bolt 243 which extends through the leaf springs 252 into the bracing axle 240 on which the bottom leaf spring 252 is seated. It is to be appreciated that an additional leaf spring(s) 252 may be added (or removed) to create a stiffer (or softer) arrangement.

In order for the wheel to be orientated correctly with respect to the trailer, the wheel axle 250 has an L-shape with a first section 250B being pivotably connected at a proximate end 251 to the mounting fixture 242 through pivot bolt 256 located in sleeve 258 of the mounting fixture 242. The first section extends perpendicularly to the longitudinal length of the bracing axle 240 and parallel to the length of the leaf springs 252. Again, upward movement of the wheel axle 250 is restricted by the leaf springs 252 as described in relation to the previous embodiments. The second section 250A of the wheel axle 250 is perpendicularly attached to the distal end 251A of the first section 250B. The second section 250A of the wheel axle 250 extends outwardly from the arrangement 222 and includes a wheel mount arrangement (not shown) which attaches to the distal coupling end 248 of the second section 250A. As can be appreciated, a wheel mount arrangement (not shown) that includes bearings, wheel rim and the like would be mounted on the distal coupling end 248.

As should be appreciated, the suspension system 222 shown in FIG. 12 can be fitted (or retrofitted to an existing trailer suspension system) to place the wheels 36 of the trailer closer to the chassis of a trailer than is possible for the suspension arrangements 22 and 122 shown in FIGS. 1 to 11 due to the L-shape of the wheel axle 250 and perpendicular arrangement of the leaf springs 252 and mounting fixture 242 relative to the bracing axle 40 (shown in FIG. 2).

Those skilled in the art will appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1. A suspension arrangement for a vehicle, the suspension arrangement including:
an axle having a proximal end which is pivotably mounted by a pivot mount to the vehicle, and a distal end which includes a mount for mounting a ground engaging means, the pivot mount allowing the distal end of the axle to move in an upward direction about the pivot mount; and
at least one leaf spring rigidly mounted to the vehicle,
wherein, in operation, at least a portion of the leaf spring engages a portion of the axle in order to resist upward movement of the distal end of the axle about the pivot mount.

2. A suspension arrangement according to claim 1, wherein the at least one leaf spring is mounted generally above the axle.

3. A suspension arrangement according to claim 1, wherein the leaf spring extends from the vehicle longitudinally along the length of the axle.

4. A suspension arrangement according to claim 1, wherein the leaf spring extends from the vehicle generally perpendicularly to the length of the axle.

5. A suspension system according to claim 1, in which the end of the leaf spring rigidly mounted to the vehicle is proximate to the pivot mount.

6. A suspension system according claim 1 including two or more leaf springs.

7. A suspension arrangement according to claim 1, wherein the at least one leaf spring includes a proximal end fastened to the vehicle and a distal end connected to the axle.

8. A suspension arrangement according claim 1, wherein each of the respective components of the suspension system are releasably secured together.

9. A suspension arrangement according to claim 8, wherein each of the respective components are fastened together using a bolting system.

10. A suspension arrangement according to claim 1 including a mounting fixture which is secured to the vehicle, the mounting fixture including the pivot mount.

11. A suspension arrangement according to claim 10, wherein the pivot mount comprises one or more bolts which releasably secure the axle to the mounting fixture.

12. A suspension arrangement according to claim 10, wherein the mounting fixture includes a leaf spring fastener in which one end of the leaf spring is rigidly mounted.

13. A suspension arrangement according to claim 12, in the leaf spring fastener includes a clamping plate arrangement which clamps one end of the leaf spring within the mounting fixture.

14. A suspension arrangement according to claim 13, wherein the clamping plate arrangement includes an upper and lower plate between which the at least one leaf spring is clamped.

15. A suspension arrangement according to claim 1, further including a fastener which is inserted though each of the leaf springs to restrain longitudinal movement of each leaf spring at that point relative to each other.

16. A suspension arrangement according to claim 15, wherein the longitudinal fastener is a pin which is inserted through each of the leaf springs.

17. A suspension arrangement according to claim 1, wherein the suspension system forms part of a wheel assembly of the vehicle.

18. A suspension arrangement according to claim 17, wherein the axle is a wheel axle and the ground engaging means is a wheel.

19. A suspension arrangement according to claim 17, wherein the wheel assembly includes two suspension assemblies which are interconnected through a bracing axle which is fastened to the mounting fixture of each suspension assembly.

20. A suspension arrangement according to claim 1, wherein the vehicle is a trailer.
